(19) United States
(12) Patent Application Publication
(10) Pub. No.: US 2006/0028811 A1
(43) Pub. Date: Feb. 9, 2006

(54) Digital video recording flashlight

(76) Inventors: Charles Andrew Ross JR., Overland Park, KS (US); Robert Dale Haler, Grain Valley, MO (US)

Correspondence Address: SPENCER, FANE, BRITT & BROWNE, 1000 WALNUT STREET, SUITE 1400, KANSAS CITY, MO, 64106-2140, US

(21) Appl. No.: 11/198,699

(22) Filed: Aug. 5, 2005

Related U.S. Application Data
(60) Provisional application No. 60/599,140, filed on Aug. 5, 2004.

(51) Int. Cl. F21L 4/00

(52) U.S. Cl. 362/157

(57) ABSTRACT

The present invention encompasses a flashlight device (10) that is capable of recording, storing, and replaying video images. The flashlight (10) comprises a light source (70) adapted to emit minimal levels of infrared light and a video sensor (80) adapted to convert images into an electronic signal. The flashlight device (10) also includes a control module (210) adapted to receive the electronic signal from the video sensor (80) and to store the images in a memory (280). A system that includes a monitor 370 or a computer 380 for utilizing such a flashlight device (10) is also disclosed.

### CROSS REFERENCE TO RELATED APPLICATIONS

This application claims the benefit of U.S. Provisional Application No. 60/599,140 entitled “Digital Video Recording Flashlight,” filed Aug. 5, 2004. Priority is claimed thereto pursuant to 35 U.S.C. § 119(e).

### STATEMENT REGARDING FEDERALLY SPONSORED RESEARCH AND DEVELOPMENT

None.

### BACKGROUND OF THE INVENTION

The present invention relates generally to flashlights. More specifically, the present invention relates to a flashlight device that is capable of recording, storing, and replaying images and to a system for utilizing such a flashlight device.

Many law enforcement officers currently have available vehicle-mounted video cameras for recording certain activities such as traffic stops. These video cameras have proven beneficial for a variety of purposes from providing evidence to ensuring the officers' safety. The currently available video cameras, however, are not removable and, therefore, are less helpful when officers must leave the vicinity of their vehicle.

Law enforcement officers and others routinely carry and use flashlights when they exit their vehicles especially at night. Combining a video recorder with a flashlight would provide the officers with the same benefits as are provided by vehicle mounted video cameras while proving to be no more of a burden to carry then the equipment already routinely carried by the officers. Flashlights combined with cameras have previously been proposed. However, such devices generally require that the light from the flashlight be turned off or that other special precautions be taken while recording so the light from the flashlight does not reduce the quality of or wash out the picture.

The present invention is designed to overcome many of the disadvantages and shortcomings associated with previously known flashlight-video recorder combinations. In particular, the present invention is a flashlight and video recorder device that reduces wash out of a video recording. The device of the present invention can be easily employed to illuminate an area and obtain a video recording of an area without any degradation of the quality of the video recording.

Accordingly, it is desirable to provide a flashlight device that is capable of recording, storing, and replaying video images, that is easy-to-use and reliable, and that produces high-quality video. It is also desirable to provide a system for utilizing such a flashlight device.

### BRIEF SUMMARY OF THE INVENTION

There is, therefore, provided in the practice of the invention a flashlight device that is capable of recording, storing, and replaying video images. The flashlight comprises a light source adapted to emit minimal levels of infrared light and a video sensor adapted to convert images into an electronic signal. The flashlight device also includes a control module adapted to receive the electronic signal from the video sensor and to store the images.

In accordance with another embodiment of the present invention, there is provided a.

In yet another embodiment of the invention, there is provided a

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention. Though some features of the invention may be claimed in dependency, each feature has merit when used independently.

### BRIEF DESCRIPTION OF THE DRAWINGS

Further features of the present invention will become apparent to those skilled in the art to which the present invention relates from reading the following description with reference to the accompanying drawings, in which:

FIG. 1 is a perspective view of a handheld flashlight constructed according to one embodiment of the present invention;

FIG. 2 is a front view of the handheld flashlight of FIG. 1;

FIG. 3 is side view of the handheld flashlight of FIG. 1;

FIG. 4 is a top view of the handheld flashlight of FIG. 1;

FIG. 5 is a bottom view of the handheld flashlight of FIG. 1;

FIG. 6 is an exploded side view of the handheld flashlight of FIG. 1;

FIG. 7 is an exploded top view of the handheld flashlight to FIG. 1;

FIG. 8 is a perspective view of a system for recording and displaying video according to one embodiment of the present invention;

FIG. 9 is a perspective view of a system for recording and displaying video according to another embodiment of the present invention;

FIG. 10 is a functional block diagram of hand held flashlight constructed according to one embodiment of the present invention; and

### DETAILED DESCRIPTION OF THE INVENTION

The present invention includes a handheld flashlight that is capable of recording, storing, and replaying video images, that is easy-to-use and reliable, and that produces high-quality video. The invention will now be described with reference to the drawing figures, in which like reference numerals refer to like parts throughout. For purposes of clarity in illustrating the characteristics of the present invention, proportional relationships of the elements have not necessarily been maintained in the Figures. Instead, the sizes of certain small components have been exaggerated for illustration.

Turning now to the figures, FIG. 1 shows a handheld flashlight 10 constructed according to one embodiment of the present invention. The flashlight 10 includes a housing 20 having a generally tubular battery storage section 30, a generally frustoconical shaped control section 40, and a generally tubular front section 50. Access to the interior of flashlight 10 may be had by removing the back end 220 of the battery storage section 30 or the front end 230 of front section 50. The ends 220 and 230 may be connected via screw threads or in any other conventional manner, and O-rings may be provided within these connections so as to help render the flashlight 10 water resistant.

The housing 20 may be formed or constructed from any suitable metal, plastic, or rubber material, or any combination thereof. In one embodiment, the housing 20 is constructed from aluminum. The housing 20 may also be comprised of a thermoplastic material, such as a polycarbonate/ABS alloy.

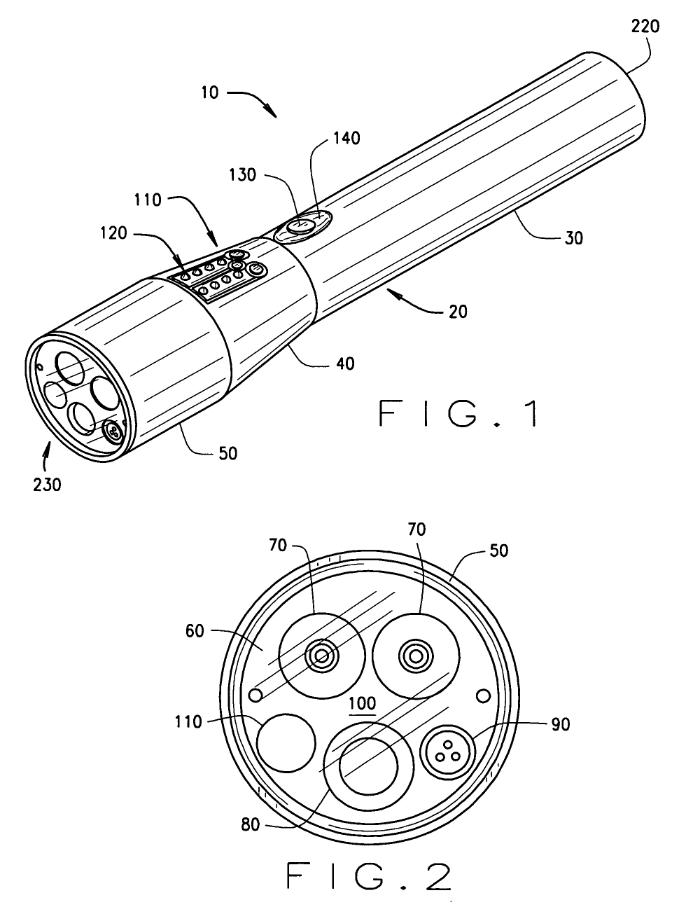

With additional reference to FIG. 2, the front section 50 includes a transparent front lens 60 at one end that covers a pair of light sources 70, a video sensor 80, and a microphone 90. The light sources 70, video sensor 80, and microphone 90 extend through a plate 100 that also contains a blank space 110 so that additional components may be added.

The front lens 60 may be formed from many materials and/or combination of materials including plastic and glass. In one embodiment, the lens 60 is made from a polycarbonate material.

Many different light bulbs and emitters may serve as a light source in this invention. Preferably, the light source will emit minimal levels of infrared light since infrared light has a negative effects on the quality of the video recording. Thus, in this embodiment, the light sources 70 are Luxeon™ solid state emitters manufactured by Lumileds Lighting of San Jose, Calif. In addition to emitting low levels of infrared light, solid state emitters offer several advantages, such as long life spans, a lack of filaments, and high lumens output.

In one embodiment, the video sensor 80 is a high resolution CMOS sensor capable of providing 510×492 color images. The sensor 80 also includes a 3.8 mm, zero magnification, 4-element coated glass lens that provides a 70 degree field of view.

With additional reference to FIGS. 3 and 4, the control section 40 includes a set of three buttons 110A, 110B, and 110C and two rows of four LED indicators 120. The operation of these buttons 110 and indicators 120 will be explained in more detail below.

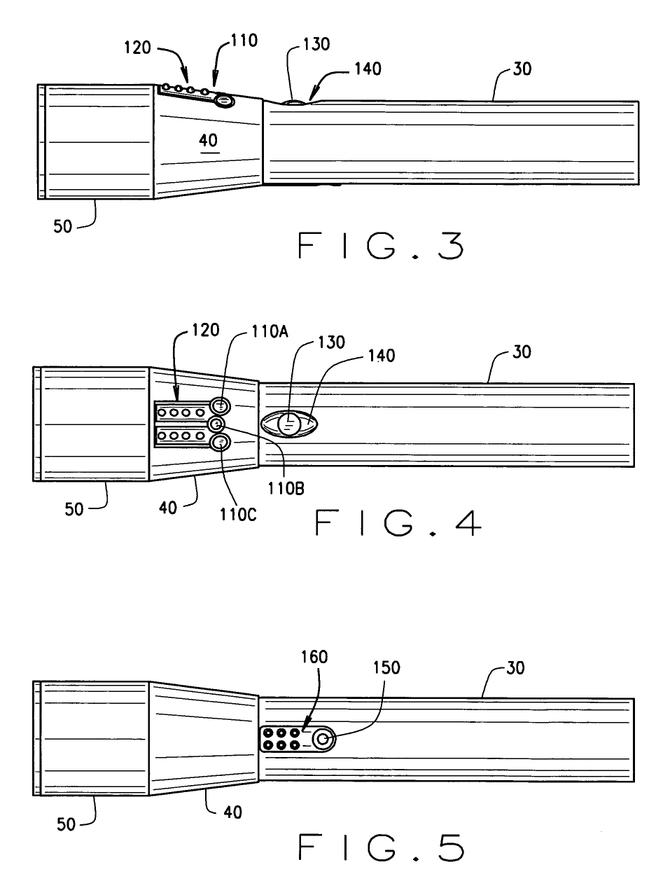

The battery storage section 30 is adapted to be held in a person's hand and contains a power push button 130 positioned in an oval-shaped recess 140. As seen in FIG. 5, battery storage section 30 also includes a jack 150 and a series of connectors 160. The purpose and operation of the jack 150 and connectors 160 will also be explained in more detail below.

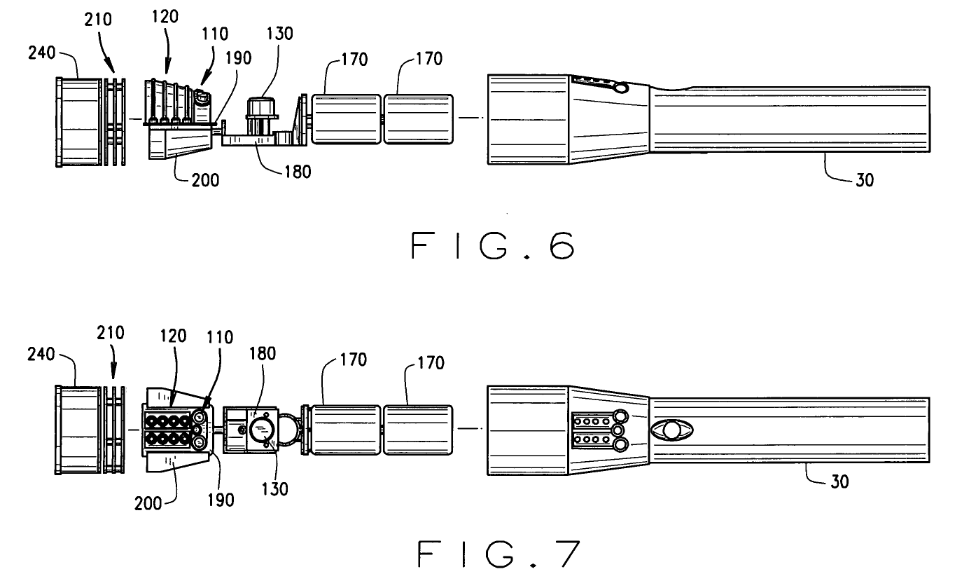

The exploded views of FIGS. 6 and 7 show various components housed within this embodiment of the flashlight 10. The components include a number of batteries 170 that are positioned in the battery storage section 30. In one embodiment, these batteries 170 are a 8.4V, AHr Lilon rechargeable battery pack that is overload, short, and thermally protected. This battery pack is both internally and externally chargeable.

Continuing with FIGS. 6 and 7, power push button 130 is mounted to a first support structure 180. Buttons 110 and LED indicators 120 are initially mounted to a board 190, and the board 190 is mounted to second support structure 200. As seen, in this embodiment, indicators 120 are an LED array with the individual LEDs enclosed and protected from harm. The front lens 60, light sources 70, video sensor 80, and microphone 90 are contained within a third support structure 240.

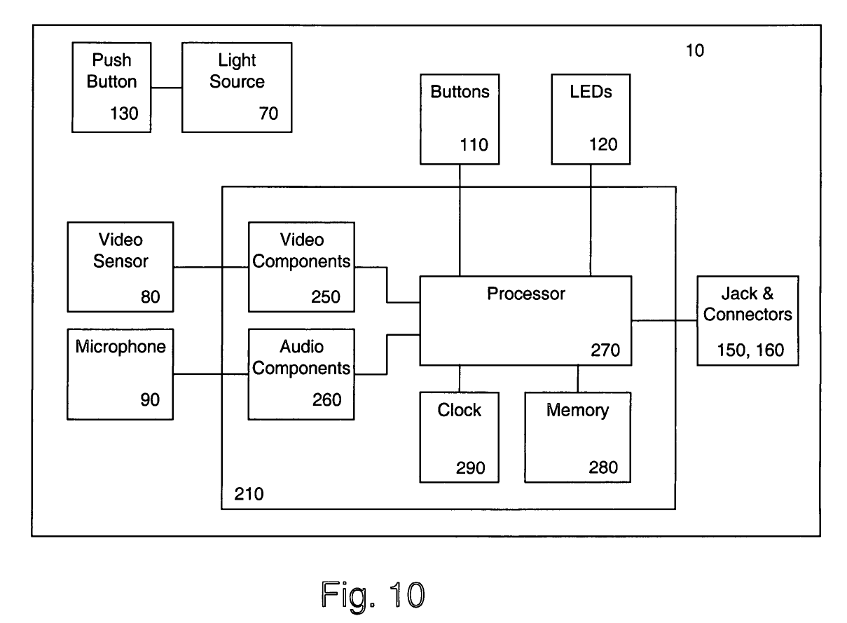

The flashlight 10 components further include an electronic control module 210 comprising individual electrical components mounted to a number of circuit boards Referring now to FIG. 10, the electronic control module 210 generally comprises video components 250, audio components 260, a processor 270, memory 280, and a clock 290. As can be seen, the video sensor 80 is in electrical communication with the video components 250 and the microphone 90 is in electrical communication with the audio components 260. The video components 250 and the audio components 260 are in electrical communication with the processor 270 as are the buttons 110, the indicators 120, the memory 280, the clock 290, the jack 150 and the connectors 160. Also shown in FIG. 10, the push button 130 is coupled to the light source 70.

As is understood by those in the relevant art, the video components 250 may include video decoder for receiving an electrical signal from the video sensor 80 and converting that signal to a signal receivable by the processor 270. In one embodiment, the video components 250 also include infrared filtering components for further enhancement of the video signal quality. The audio components 260 may include a preamplifier and an audio analog-to-digital converter for receiving an electrical signal from the microphone 90 and converting that signal to a signal receivable by the processor 270. Of course, other components including analog-to-digital converters, amplifiers, and the like may be included in the video components 250 and the audio components 260.

Continuing with FIG. 10, the memory 280 may be or may not be permanent and may or may not be removable. In one embodiment, the memory 280 is a combination of random access memory and low voltage flash memory. The clock 290 is operable to provide date and time information, and may be a serial alarm real-time clock.

In one embodiment the processor 270 is a digital signal processor. As is understood, the processor 270 is operable to receive signals from the video components 250 and the audio components 260, to further process those signals if necessary, and to store the information in memory 280. The processor 270 may also retrieve information from memory 280 and communicate information to the connectors 160 or the jack 150. The processor 270 receives input from the buttons 110 and provides status indications on the LEDs 120. The processor also receives information from the clock 290 and may incorporate that information with the video and audio information.

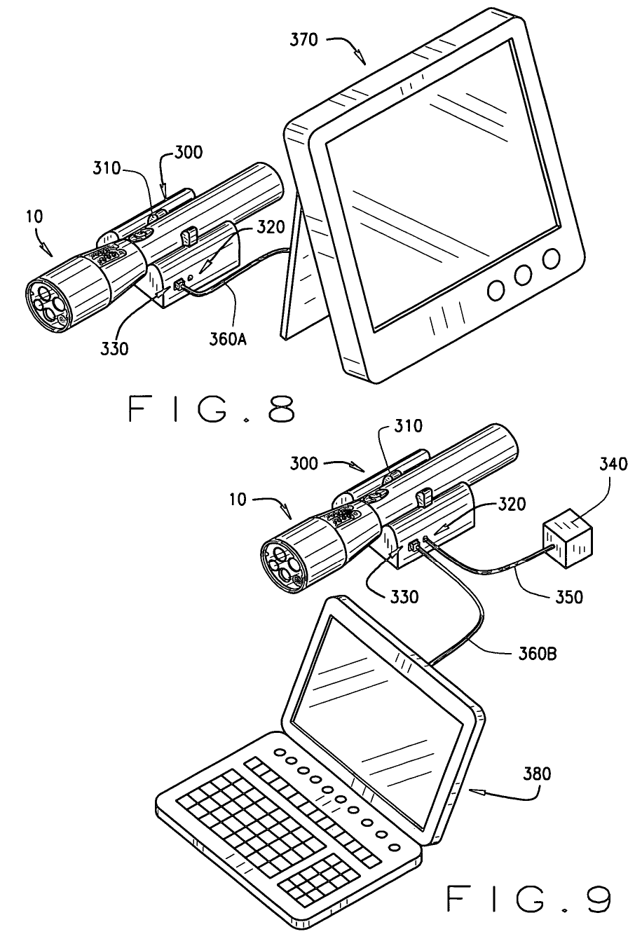

Turning now to FIGS. 8 and 9, the flashlight 10 of the present invention may be an element of a system for recording, storing, and reviewing video images. In addition to the flashlight 10, in one embodiment, the system includes a cradle 300. The cradle 300 is formed to receive and retain the flashlight 10. To retain the flashlight 10, the cradle may include a retaining device, such as a spring 310. The cradle 300 also includes a first jack 320 for receiving a connector from a power source for recharging the batteries 170. In one embodiment, the power source may be a vehicle battery, while in another embodiment the power source is line current available at a typical wall outlet. In both of these embodiments the power source includes an adapter 340 and a cord 350.

The cradle 300 also includes a second jack 330 for receiving a connector, such as a USB connector, from a cable 360. It should also be understood that the second jack is in communication with the electronic control module 210, and more specifically with the processor 270, so that information may be communicated to devices connected to the second jack 330. In FIG. 8, an external monitor 370 is connected to the second jack 330 through cable 360A. In FIG. 9, a computer 390 is connected to the second jack 330 by cable 360B. Other connection configurations exist, such as connecting an external monitor 370 directly to the flashlight 10 by coupling a cable to jack 150, and are within the scope of this agreement.

In operation, depressing push button 130 activates/deactivates the light sources 70, and the LED indicators 120 show status information, for example, power on/off, low battery, play, record, and the amount of memory remaining. It should be understood that the status of the light sources 70 does not affect recording, that is, recording may occur whether the light sources are on or off. It should also be understood that the operation of the LED indicators 120 is also independent of the status of light sources 70 except, of course, if one of the LED indicators 120 represents whether the light source 70 power is on or off.

Continuing, in one embodiment, when the flashlight 10 is out of the cradle 300, depressing button 10B starts and stops recording and depressing button 110C will turn the LED indicators 120 on and off. Thus, an officer may turn off the light sources 70 and the LED indicators 120 so as to prevent detection but keep recording images and sound.

When the flashlight 10 is recording, electrical signals produced by the video sensor 80 and microphone 90 are sent to the processor 270 through video components 250 and the audio components 260. Thereafter, the microprocessor stores the digitized images and sounds in files in memory 280 and may send the files to a removable storage or memory device. The memory device may be a flash memory card or any other known memory device that is removable and capable of holding and storing images for long term storage.

As can be appreciated, the processor 270 operates in accordance with a program stored in the processor's program memory or in a separate memory chip. The processor 270 is programmed to respond to the buttons 110. In order to operate the flashlight 10, a user may press the various push buttons 110 in various predetermined sequences. Thus, as describe above, pressing the center button 10B while in the field generally will start a recording.

When a cable connector from an external monitor, such as monitor 370, is coupled to the jack 150 or to one or more of connectors 160, the processor will initiate and cause to be displayed a menu program and the buttons 110 may be used to navigate through this menu and select options. When directed by an appropriate menu selection, the processor 270 will stream information from the memory 280 to the output jack 150 or one or more of the connectors 160 and from there to the monitor. Other options may allow the memory to be rewritten and other video images stored therein.

In shown in FIG. 9, the flashlight 10 may also be connected to a computer 380 in order to achieve some interactivity with the processor 270. Thus, in addition to the programming mentioned above, the processor 270 may include software that allows a user to modify flashlight configurations, such as video resolution, or to modify, erase, or lock/unlock files. The software may also allow a user to transfer or download files in addition to playing those files. The system may include security features such as requiring a user to input a password and then comparing that password to one stored in memory 280.

Having described the invention, it should be apparent that the invention is both inexpensive and easy to implement and use especially when compared to current identity-preserved tracing programs. Additionally, the system is scalable to large marketing systems and could be used across the entire market for a given commodity. Although the above system and method are described using wheat, as stated above, it will be appreciated that system and method are equally applicable to other commodities. Additionally, from the above description of the invention, those skilled in the art will perceive improvements, changes and modifications. Such improvements, changes and modifications within the skill of the art are intended to be covered by the appended claims.

Having described at least one preferred embodiment of the invention, what is claimed is:

1. A flashlight device comprising:
a light source adapted to emit minimal levels of infrared light;
a video sensor adapted to convert images into an electronic signal; and
an control module adapted to receive the electronic signal from the video sensor and to store the images.

2. The flashlight device of claim 1 wherein the light source is a solid state emitter.

3. The flashlight device of claim 1 wherein the control module further includes an infrared filter.

4. The flashlight device of claim 1 wherein the control module includes memory for storing the images.

5. The flashlight device of claim 4 wherein the memory is removable.

6. The flashlight device of claim 1 further including a microphone for recording audio signals and wherein the control module is adapted to receive the electronic signals from the microphone and to store the audio signals.

7. The flashlight device of claim 1 wherein the control module include a digital signal processor.

8. The flashlight device of claim 1 further including a power supply.

9. The flashlight device of claim 8 wherein the power supply is rechargeable.

10. A system for recording and displaying video images, the system comprising:
a handheld flashlight having a light source adapted to emit minimal levels of infrared light, a video sensor adapted to convert images into an electronic signal, and a control module adapted to receive the electronic signal from the video sensor, to store the images, and to produce an electronic signal representing the stored images; and
a computer operable to communicate with the control module, to receive the electronic signal produce by the control module, and to display the images represented by that electronic signal.

11. The system of claim 10 further including a cradle shaped to receive the handheld flashlight, the cradle adapted to allow the control module to communicate with the computer.

12. The system of claim 10 wherein the flashlight further comprises a power supply and cradle is further adapted to allow charging of the flashlight power supply.

13. The system of claim 10 wherein the control module includes memory.

14. The system of claim 13 wherein the memory of the control module contains a password required from a user before the user is allowed access to the memory.

15. The system of claim 10 wherein the computer is operable to direct the control module to download image from the control module to the computer.

16. The system of claim 10 wherein the flashlight light source is a solid state emitter.

17. A system for recording and displaying video, the system comprising:
a handheld flashlight having a light source adapted to emit minimal levels of infrared light, a video sensor adapted to convert images into an electronic signal, and a control module adapted to receive the electronic signal from the video sensor, to store the images, and to produce an electronic signal representing the stored images; and
a monitor operable to receive the electronic signal produced by the control module and to display the images represented by that electronic signal.

18. The system of claim 17 wherein the control module includes memory containing programming instructions for producing a menu on the monitor.

19. The system of claim 18 further including a plurality of push buttons coupled to the control module and wherein the control module interprets the state of the push buttons to navigate through the menu.

20. The method of claim 17 wherein the flashlight light source is a solid state emitter.
